(19) United States
(12) Patent Application Publication
(10) Pub. No.: US 2003/0089823 A1
(43) Pub. Date: May 15, 2003

(54) Method for powering a drive

(76) Inventor: Norbert Auner, Frankfurt/Main (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/258,761

(22) PCT Filed: Apr. 24, 2001
(86) PCT No.: PCT/DE01/01544

(30) Foreign Application Priority Data
Apr. 26, 2000 (DE) 10020363.9

(51) Int. Cl. B64C 5/00; B64C 9/00; B64C 13/00

(52) U.S. Cl. 244/75 R

(57) ABSTRACT

A method of operating a drive mechanism, especially missile propulsion system or shaft drive system, is described. According to this method nitrogen and/or nitrogen compounds are reacted with silicon and/or silicon compounds by means of a subgroup element or subgroup element oxide in a reaction chamber wherein silicon nitride is formed and the energy set free during this reaction is used for the operation of the drive mechanism.

The present invention is directed to a method of operating a drive mechanism, especially missile propulsion system or shaft drive mechanism, according to which nitrogen and/or nitrogen compounds are reacted with silicon and/or silicon compounds in a reaction chamber and silicon nitride is formed and the energy set free by this reaction is used for operating the drive mechanism.

From DE 44 37 524 A1 a method of operating a reaction-type missile propulsion system is known according to which the hydrogen of silicon hydride compounds is burned for water in the presence of an oxydizing agent supplying oxygen for the generation of high temperatures, whereupon at the temperatures generated during the formation of water the hydrogen of the air and/or of nitrogen compounds carried along is reacted with the silicon of the silicon hydride compounds for the formation of silicon nitride. According to this method preferably the nitrogen of the atmosphere of the earth is used for the reaction. As silicon hydride compounds preferably silane oils (higher silanes) are used.

Since the silicon nitride (Si₃N₄) essentially formed by the nitrogen combustion has a substantially higher molecular weight than the carbon dioxid generated with jets an especially high efficiency of the drive mechanism is reached. Furthermore, nitrogen is present in large amounts so that, on the whole, a high efficiency with low costs results.

From DE 196 12 507 A1 a method of driving a shaft is known according to which silicon hydrides are burnt with nitrogen of the air, too. In order to save costs with this method and to completely exclude a silicon/oxygen combustion preferably powder-like silicon or metal silicides, for instance magnesium silicide, are added to the silicon hydrides. In this manner the 80% nitrogen portion of the air is reacted in a stochiometric manner.

Nitrogen is an inert gas and reacts only above 1100° C. with silicon powder for silcon nitride Si₃N₄ according to the following equation:

3Si+2N₂→Si₃N₄+750 kJ

During the combustion of silicon hydride compounds, especially silane oils, with compressed air the oxygen portion of the air reacts with the hydrogen of the silane chain according to the equation

4H+O₂=2H₂O.

During this hydrogen-oxygen-combustion temperatures of about 3000° C. are reached. This temperature is sufficient in order to crack the N₂-molecule which is presented by the supply of the compressed air.

According to the equation

4N+3Si=Si₃N₄

the nitrogen radicals now attack the free silicon atoms with extreme vehemence. Silicon nitride is formed. Now, the described reaction takes place at correspondingly high temperatures. In other words, at a sufficiently high temperature the silicon hydride compounds are ultimately thermally decomposed into Si+H.

Furthermore, it is known to generate Si₃N₄ by heating silicon powder onto 1250-1450° C. in a nitrogen atmosphere.

It is the object of the present invention to provide a method of the above-cited kind which has an especially high energy yield on the basis of a simple and rapid course.

According to the invention this object is reached with a method of the cited kind by reacting the nitrogen of the air and/or of nitrogen compounds carried along with silicon and/or silicon compounds by means of a subgroup element or subgroup element oxide in a reaction chamber for the. formation of silicon nitride and by using the energy set free by this reaction for operating the drive mechanism.

Surprisingly, one came to know that the silicon is activated in such a manner by the use of the subgroup element or subgroup element oxide that the N₂-cracking and thus the reaction of silicon with nitrogen is initiated or accelerated. With “subgroup elements” here the corresponding elements of the subgroups of the periodic system of elements are meant. Subgroup element oxides are the oxides therefrom. Especially good results can be obtained with the elements of the subgroup of group I, namely Cu, Ag, Au, wherein the use of copper or copper oxide (CuO) brings along especially good results.

At the moment, it is still not clear whether the used subgroup element or subgroup element oxide operates as initiator, activator or catalyst. Anyway, it is clear that a reaction of the silicon or of the silicon compound with nitrogen for silicon nitride results by the presence of the subgroup element or subgroup element oxide, wherein this reaction is combined with a rapid temperature increase (exothermic reaction) which results in the desired especially high energy yield. Accordingly, a rapid temperature increase in the reaction chamber onto 1000° C. and more was observed.

Especially good results are obtained if a powder of silicon and/or a silicon compound is used. Especially preferred is a powder with a particle size of about 15-25 μm. If it is emanated from the fact that the used subgroup element or subgroup element oxide initiates the desired exothermic reaction of the silicon with nitrogen, obviously, the initiating temperature is the lower the lower the particle size of the silicon or of the silicon compound is.

The subgroup element or subgroup element oxide is preferably used in powder form either, practically as mixture with the powder of silicon and/or the silicon compound. According to an especially preferred embodiment the silicon and/or the silicon compounds are reacted as powder coated with the subgroup element or subgroup element oxide.

Practically, a powder of silicon and/or a silicon compound with activated surface is used.

According to a special variant of the method in a first step, the reaction with the subgroup element or subgroup element oxide is initiated, especially by external heating and/or carrying out an exothermic pre-reaction. For example, such a pre-reaction can be carried out with chloromethane wherein from the reaction of silicon and chloromethane sufficient adiabatic heat is generated in order to start the reaction of silicon with the subgroup element or subgroup element oxide.

According to another alternative of the inventive method a mixture of silicon and/or a silicon compound and the subgroup element or subgroup element oxide is only used as ignition mixture in the reactor since the reaction of silicon with N₂ generates sufficient heat in order to be self-preserving. On account of the small particle size the used powder mixture is substantially gas-impermeable so that the nitrogen introduced into the reaction chamber is only pressed upon as gas and a reaction front runs through the reaction chamber. According to another variant of the inventive method the reaction mixture is provided in porous form (is conditioned) and the nitrogen gas is passed through the mixture (bulk material). This method has advantages for the cooling of the reactor and enables the use of gas mixtures (nitrogen and inert gas) in order to control the heat development by the reaction. Furthermore, the heat development in the reactor occurs locally more homogeneous.

With the inventive method preferably nitrogen gas is used. In contrast to the known methods for preparing silicon nitride by heating silicon powder onto 1250-1450° C. in a nitrogen atmosphere according to the inventive method very low initiating temperatures (about 100-300° C.) are necessary in order to let the reaction take place exothermally. Of course, nitrogen-containing mixtures or nitrogen compounds can be used either if by this the desired reaction course with silicon is obtained with the initiating, activating or catalysing effect of the added subgroup element or subgroup element oxide.

Preferably, copper or copper oxide is used as subgroup element or subgroup element oxide wherein copper oxide (CuO) is especially preferred.

When using silicon compounds preferably silicon hydride compounds, especially silanes, particularly silane oils, are used, wherein such compounds are preferred which have a chain length of Si₅H₁₂ to Si₉H₂₀. Such silanes have the consistency of paraffin oils and can be prepared in an industrial manner. They can be pumped so that they can be supplied to a suitable reaction chamber without problems.

According to an embodiment of the inventive method preferably the hydrogen of the silicon hydride compounds is burnt for water in the presence of an oxygen supplying oxidation agent for the generation of high temperatures whereupon the reaction of the nitrogen with the silicon by means of the subgroup element or subgroup element oxide follows.

Silicides can be also used as silicon compounds.

In order to react the nitrogen with the silicon of silicon hydride compounds, especially silanes, it can be advantageous to add elementary silicon to the used silicon hydride compound which elementary silicon is reacted with the nitrogen by means of the used element or oxide either. In addition to elementary silicon silicides can be mixed for this purpose.

Then, the following stochiometrically 100% combustion of a normal air mixture of 20% O₂ and 80% N₂ results with a heptasilane Si₇H₁₆ by using the described measures (catalyst):

16H+4O₂→8H₂O

7Si+16N₂+additionally 17 dispersed, activated

Si→8Si₃N₄.

Accordingly, with the invention Si and/or Si compounds can be reacted in an accelerated manner with high energy yield for silicon nitride. The energy set free during this reaction can be used for operating a drive mechanism, for instance missile propulsion systems, as rocket drive systems, shaft drive systems etc. Such drive mechanisms are described in the above-cited prior art and are no more described in detail here. The disclosure of this prior art is herewith completely incorporated into the present application.

The effect of the subgroup element or subgroup element oxide can be increased by promoters, as for instance zinc, zinc compounds.

The above-described reaction of silicon hydrides with nitrogen can be also realized with substituted silanes. For instance, tetramethylsilane (CH₃)₄Si which can be technically easily prepared can be reacted with nitrogen.

Silicon or silicon hydride compounds (silanes) can be also added to other conventional fuels or incorporated into the same in order to contribute to an increasing output by the above-described reaction with nitrogen. So, for instance, one or more silicon atoms can be incorporated into the chemical molecule structure of carbon petrol. For this, the above-mentioned tetramethylsilane can be used, for example.

Furthermore, silicon-containing (silane-containing) petrols can be used in ceramic motors with high operation temperatures. In combustion chambers, the inner walls and mechanical elements of which are possibly coated with silicon nitride, silicon carbide etc., the combustion product silicon nitride which is liquid/gaseous at the high temperatures can be used as lubricant which enters into the system by the combustion itself and is thus always present in a sufficient manner.

Preferably, nitrogen gas is used for carrying out the inventive method. However, mixtures or nitrogen and other gasses can be used either wherein or course air (atmospheric air) is especially preferred on account of its presence. In addition to pure silicon ferrosilicon can be used either.

With the inventive method any drive mechanism can be operated. The term “shaft drive mechanism” is to cover any motors, turbines etc., for instance also stirling engines and turbine engines. Especially rocket propulsion systems belong to the “missile propulsion systems”.

A substantial aspect of the inventive method results in the fact that the method is substantially CO₂-free and NOₓ-free since the final product is substantially only silicon nitride. The method operates with an especially high efficiency. Accordingly, the environmental problems of today which are caused by conventional drive methods are removed with the inventive method.

If instead of nitrogen gas air is introduced with the inventive method it is clear that the oxygen of the air will react with the silicon either so that also SiO₂ in a certain amount is generated with the inventive method. The oxidation portion can be varied by controlling the addtion of air in order to obtain the desired intended nitrogen combustion. The expert in the art can optimally adjust the reaction.

Another advantage of the inventive method consists in the fact that the obtained silicon nitride can be used as starting product for further processes.

In the preceding text it was always emanated from the fact that the used subgroup element or subgroup element oxide causes an activation of the silicon. However, it cannot be excluded that this element or oxide causes instead or additionally an activation of the nitrogen so that the same can react with the silicon correspondingly. The invention covers both possibilities.

In the following the invention is described by means of an example in detail.

Silicion powder (particle size 15-25 μm) with activated surface is mixed with 30% CuO and introduced into a metal reactor or glass reactor. Chloromethane is introduced, and the reactor is externally heated (about 150° C.). After a short time (some minutes) the reaction of silicon and chloromethane supplies enough adiabatic heat in order to let start the reaction of silicion with copper oxide which can be recognized by the formation of a copper mirror at the reactor wall. Now, nitrogen is introduced which reacts with the silicon to silicon nitride wherein the temperature in the reactor rapidly increases to 1000° C. With this educt ratio adiabatic temperature increases for about 6000° C. are to be expected. The used educt mixture is substantially gas-impermeable on account of the small particle size so that nitrogen is only pressed upon and a reaction front runs through the reactor. It is also possible to prepare the reaction mixture in a porous form and to pass the nitrogen gas through the bulk material. This would bring along advantages with the reactor cooling and would enable the use of gas mixtures (nitrogen and inert gas) in order to control the heat development through the reaction. Furthermore, the heat development in the reactor would locally occur more homogeneous.

The reaction with chloromethane placed before can be replaced by intensive external heating since it supplies only heat which causes the start of the reaction with copper oxide. This is realized with activated silicon at 190° C.

Furthermore, it is possible that the mixture of CuO and silicon powder is only used as ignition mixture in the reactor since the reaction of silicon with N₂ generates sufficient heat in order to be self-preserving.

Up to now the reaction steps have been carried out only in insufficiently cooled reactors Bo that the nitrogen reaction had to be stopped by the introduction of argon in order to prevent a melting of the reactor. Nevertheless, the reaction yield is more than 80% (23% N in the reactor content; theoretically: 0.7×40%=28%). Note: 6% O in the educt mixture, i.e. 3% of the Si react with O.

1. A method of operating a drive mechanism, especially missile propulsion system or shaft drive system, according to which nitrogen and/or nitrogen compounds are reacted in a reaction chamber with silicon and/or silicon compounds by means of a subgroup element or subgroup element oxide with the formation of silicon nitride, and the energy set free during this reaction is used for the operation of the drive mechanism.

2. The method according to claim 1, characterized in that a powder of silicon and/or a silicon compound is used.

3. The method according to claim 2, characterized in that a powder having a particle size of about 15-25 μm is used.

4. The method according to claim 2 or 3, characterized in that a powder of the subgroup element or subgroup element oxide is used.

5. The method according to one of the claims 2-4, characterized in that a powder of silicon and/or a silicon compound with activated surface is used.

6. The method according to one of the preceding claims, characterized in that in a first step the reaction with the subgroup element or subgroup element oxide is initiated especially by external heating and/or carrying out a pre-reaction.

7. The method according to claim 6, characterized in that chloromethane is introduced into the reaction chamber for carrying out the pre-reaction.

8. The method according to one of the preceding claims, characterized in that a mixture of silicon and/or a silicon compound and the subgroup element or subgroup element oxide is only used as ignition mixture in the reactor.

9. The method according to one of the preceding claims, characterized in that the reaction mixture is provided in a porous form and the nitrogen gas is passed through the mixture.

10. The method according to one of the preceding claims, characterized in that copper or copper oxide is used as subgroup element or subgroup element oxide.

11. The method according to one of the preceding claims, characterized in that the silicon and/or the silicon compounds are reacted as powder coated with the subgroup element or subgroup element oxide.

12. The method according to one of the preceding claims, characterized in that silicon hydride compounds, especially silanes, particularly silane oils, are used as silicon compounds.

13. The method according to one of the preceding claims, characterized in that the hydrogen of the silicon hydride compounds is burnt to water in the presence of an oxidizing agent supplying oxygen for the generation of high temperatures, whereupon the reaction of the nitrogen with the silicon by means of the subgroup element or subgroup element oxide follows.

14. The method according to one of the preceding claims, characterized in that carbon hydride compounds with incorporated silicon atoms are used as silicon compounds.
